(19) United States
(12) Patent Application Publication
(10) Pub. No.: US 2020/0173842 A1
(43) Pub. Date: Jun. 4, 2020

(54) MOBILE VIBRATION DETECTING DEVICE AND DETECTING METHOD THEREOF

(71) Applicant: TECOM CO., LTD., Hsin-Chu (TW)

(72) Inventors: Chun-Hung CHEN, Hsin-Chu (TW); Yi-Hsien CHOU, Hsin-Chu (TW); Mei-Jung YAO, Hsin-Chu (TW)

(21) Appl. No.: 16/243,866

(22) Filed: Jan. 9, 2019

(30) Foreign Application Priority Data
Nov. 29, 2018 (TW) 107142683

(51) Int. Cl. G01H 1/00

(52) U.S. Cl. CPC G01H 1/003

(57) ABSTRACT

A mobile vibration detecting device comprising a vibration detecting unit, an analog-to-digital converting unit, a first band-pass filtering unit, a transform calculation module, a RMS transform module, a packet generating module, and a communication/transmission module is provided. The vibration detecting unit is utilized for generating an acceleration analog signal. The analog-to-digital converting unit is utilized for generating an acceleration digital signal accordingly. The first band-pass filtering unit and the transform calculation module are utilized for generating a velocity digital signal accordingly. The RMS transform module receives the acceleration digital signal and the velocity digital signal to generate an acceleration RMS transform data and a velocity RMS transform data accordingly. The packet generating module and the communication/transmission module transmit the above mentioned data for a detecting person standing by the motorized machine to read directly.

This application claims the benefit of Taiwan Patent Application Serial No. 107142683, filed on Nov. 29, 2018, the subject matter of which is incorporated herein by reference.

### BACKGROUND OF INVENTION

### 1. Field of the Invention

The present invention is related to a vibration detecting device, and more particularly is related to a mobile vibration detecting device.

### 2. Description of the Prior Art

Vibration exists with the rotation of motors. When a motor is applied to a motorized machine, such as the air compressor, the water pump, the decelerator, and etc., motor vibration may cause vibration problems for the motorized machine.

Because the motor or the motorized machine under abnormal conditions has a vibration pattern different from that under the normal condition, it is common for the detecting person to use a vibration detecting device to detect the condition of the motor or the motorized machine. The vibration detecting device is utilized for detecting vibration acceleration and vibration velocity of the motor or the motorized machine.

However, vibration acceleration data and vibration velocity data detected by the conventional vibration detecting device are analog signals. The vibration detecting device should pass the analog signals to the back end for executing further calculation, such as Root-Mean-Square (RMS) calculation, Fast Fourier Transform (FFT) calculation, Kurtosis calculation, and etc., to convert the analog signals into the detecting person readable digital signals.

Thus, the detecting person may spend a lot of time detecting the vibration acceleration data and the vibration velocity data to figure out that the motor or the motorized machine is fine without any abnormal condition, or has an abnormal condition after the calculation of the back end. However, the motor or the motorized machine keeps operating during the detection executed by the detecting person and the calculation of the back end, which may further damage the motor or the motorized machine, reduce the life of the motor or the motorized machine, or even cause a safety threat to the detecting person.

In addition, the analog signal is often disturbed by the noise during the transmission to the back end to cause signal distortion, and the cost of back end calculation is high.

### SUMMARY OF THE INVENTION

As mentioned, various problems are generated due to the issue that the conventional vibration detecting device can only generate the unreadable analog signals. Accordingly, it is a main object of the present invention to provide a mobile vibration detecting device for resolving the problems of the prior art.

A mobile vibration detecting device for resolving the aforementioned problems is provided in the present invention. The mobile vibration detecting device is utilized to be carried by a detecting person and disposed on a motorized machine for detecting at least one vibration-related data of the motorized machine. The mobile vibration detecting device comprises a vibration detecting unit, an analog-to-digital converting unit, a first band-pass filtering unit, a transform calculation module, a root-mean-square (RMS) transform module, a packet generating module, and a communication/transmission module.

The vibration detecting unit is utilized to be fixed to the motorized machine for detecting a plurality of acceleration pulses within a detecting time period to generate an acceleration analog signal. The analog-to-digital converting unit is electrically connected to the vibration detecting unit for receiving the acceleration analog signal to generate an acceleration digital signal. The first band-pass filtering unit is electrically connected to the analog-to-digital conversion unit for filtering the acceleration digital signal. The transform calculation module is electrically connected to the first band-pass filtering unit for receiving the acceleration digital signal to generate a velocity digital signal. The RMS transform module is electrically connected to the first band-pass filtering unit and the transform calculation module for receiving the acceleration digital signal and the velocity digital signal to generate an acceleration RMS transform data and a velocity RMS transform data respectively.

The packet generating module is electrically connected to the RMS transform module for receiving the acceleration RMS transform data and the velocity RMS transform data to generate an acceleration RMS transform data packet and a velocity RMS transform data packet respectively. The communication/transmission module is electrically connected to the packet generating module for receiving and transmitting the acceleration RMS transform data packet and the velocity RMS transform data packet.

Wherein, the acceleration RMS transform data packet and the velocity RMS transform data packet are provided to a display module adjacent to the motorized machine to display the acceleration RMS transform data and the velocity RMS transform data represented by the acceleration RMS transform data packet and the velocity RMS transform data packet respectively for the detecting person to read.

In accordance with an embodiment of the present invention, the transform calculation module of the mobile vibration detecting device includes an integration unit, which is utilized for integrating the acceleration digital signal into the velocity digital signal.

In accordance with an embodiment of the present invention, the transform calculation module of the mobile vibration detecting device includes a second band-pass filtering unit, which is utilized for generating the velocity digital signal.

In accordance with an embodiment of the present invention, the mobile vibration detecting device further comprises a Fast Fourier Transform module, which is electrically connected to the first band-pass filtering unit, the transform calculation module, and the packet generating module for receiving the acceleration digital signal and the velocity digital signal to generate an acceleration Fourier Transform data and a velocity Fourier Transform data respectively, the packet generating module is utilized for receiving the acceleration Fourier Transform data and the velocity Fourier Transform data to generate an acceleration Fourier Transform data packet and a velocity Fourier Transform data packet respectively, and the acceleration Fourier Transform data packet and the velocity Fourier Transform data packet are transmitted by the communication/transmission module.

In accordance with an embodiment of the present invention, the mobile vibration detecting device further comprises a clock generation unit and a frequency comparing unit. The frequency comparing unit is electrically connected to the analog-to-digital conversion unit and the clock generation unit for receiving the acceleration digital signal to generate a frequency difference.

In accordance with an embodiment of the present invention, the Fast Fourier Transform module of the mobile vibration detecting device comprises a window filtering unit, a Fast Fourier Transform calculation unit, and a frequency adjusting unit. The window filtering unit is utilized for filtering the acceleration digital signal and the velocity digital signal. The Fast Fourier Transform calculation unit is electrically connected to the window filtering unit for transforming the filtered acceleration digital signal and the filtered velocity digital signal by using Fast Fourier Transform to generate an original acceleration Fourier Transform data and an original velocity Fourier Transform data. The frequency adjusting unit is electrically connected to the Fast Fourier Transform calculation unit and the frequency comparing unit for receiving the frequency difference, the acceleration Fourier Transform data, and the original velocity Fourier Transform data, and using the frequency difference to execute a frequency difference adjusting calculation to the acceleration Fourier Transform data and the original velocity Fourier Transform data to generate the acceleration Fourier Transform data and the velocity Fourier Transform data.

In accordance with an embodiment of the present invention, the mobile vibration detecting device further comprises a Kurtosis transform module, which is electrically connected to the first band-pass filtering unit and the packet generating module for receiving the acceleration digital signal to generate a Kurtosis transform data, the packet generating module is utilized for receiving the Kurtosis transform data to generate a Kurtosis transform data packet, and the Kurtosis transform data packet is transmitted by the communication/transmission module.

In accordance with an embodiment of the present invention, the Kurtosis transform module of the mobile vibration detecting device comprises an average calculation unit and a Kurtosis calculation unit. The average calculation unit is utilized for calculating an average value, and the Kurtosis calculation unit is electrically connected to the average calculation unit for receiving the average value to generate the Kurtosis transform data.

A mobile vibration detecting method, which uses the mobile vibration detecting device of claim 1 to detect at least one vibration-related data of the motorized machine, is also provided in the present invention. The mobile vibration detecting method comprises the following steps (a) to (g).

Step (a): detecting a plurality of acceleration pulses within a detecting time period to generate an acceleration analog signal by using the vibration detecting unit.

Step (b): receiving the acceleration analog signal to generate an acceleration digital signal by using the analog-to-digital conversion unit.

Step (c): filtering the acceleration digital signal by using the first band-pass filtering unit.

Step (d): receiving the acceleration digital signal to generate a velocity digital signal by using the transform calculation module.

Step (e): receiving the acceleration digital signal and the velocity digital signal to generate an acceleration RMS transform data and a velocity RMS transform data respectively by using the RMS transform module.

Step (f): receiving the acceleration RMS transform data and the velocity RMS transform data to generate an acceleration RMS transform data packet and a velocity RMS transform data packet respectively by using the packet generating module.

Step (g): receiving and transmitting the acceleration RMS transform data packet and the velocity RMS transform data packet by using the communication/transmission module.

In accordance with an embodiment of the present invention, the mobile vibration detecting device used in the mobile vibration detecting method further comprises a Fast Fourier Transform module, which is electrically connected to the first band-pass filtering unit, the transform calculation module, and the packet generating module, and the mobile vibration detecting method further comprises the following steps (h) to (j).

Step (h): receiving the acceleration digital signal and the velocity digital signal to generate an acceleration Fourier Transform data and a velocity Fourier Transform data respectively by using the Fast Fourier Transform module;

Step (i): receiving the acceleration Fourier Transform data and the velocity Fourier Transform data to generate an acceleration Fourier Transform data packet and a velocity Fourier Transform data packet respectively by using the packet generating module.

Step (j): receiving and transmitting the acceleration Fourier Transform data packet and the velocity Fourier Transform data packet by using the communication/transmission module.

In accordance with an embodiment of the present invention, the mobile vibration detecting device used in the mobile vibration detecting method further comprises a Kurtosis transform module, which is electrically connected to the first band-pass filtering unit and the packet generating module, and the mobile vibration detecting method further comprises the following steps (k) to (m).

Step (k): receiving the acceleration digital signal to generate a Kurtosis transform data by using the Kurtosis transform module.

Step (l): receiving the Kurtosis transform data to generate a Kurtosis transform data packet by using the packet generating module.

Step (m): receiving and transmitting the Kurtosis transform data packet by using the communication/transmission module.

As mentioned, the mobile vibration detecting device and the detecting method thereof provided in the present invention is capable of providing the readable information to the detecting person standing by the motorized machine without the need of back end calculation, such that the problems of the prior art caused by signal transmission to the back end can be resolved.

### BRIEF DESCRIPTION OF THE DRAWINGS

The present invention will now be specified with reference to its preferred embodiment illustrated in the drawings, in which:

FIG. 1 is a block diagram showing a mobile vibration detecting device in accordance with a preferred embodiment of the present invention;

FIG. 2 is a flow chart showing a mobile vibration detecting method in accordance with a first preferred embodiment of the present invention;

FIG. 3 is a flow chart showing a mobile vibration detecting method in accordance with a second preferred embodiment of the present invention; and

FIG. 4 is a flow chart showing a mobile vibration detecting method in accordance with a third preferred embodiment of the present invention.

### DESCRIPTION OF THE PREFERRED EMBODIMENT

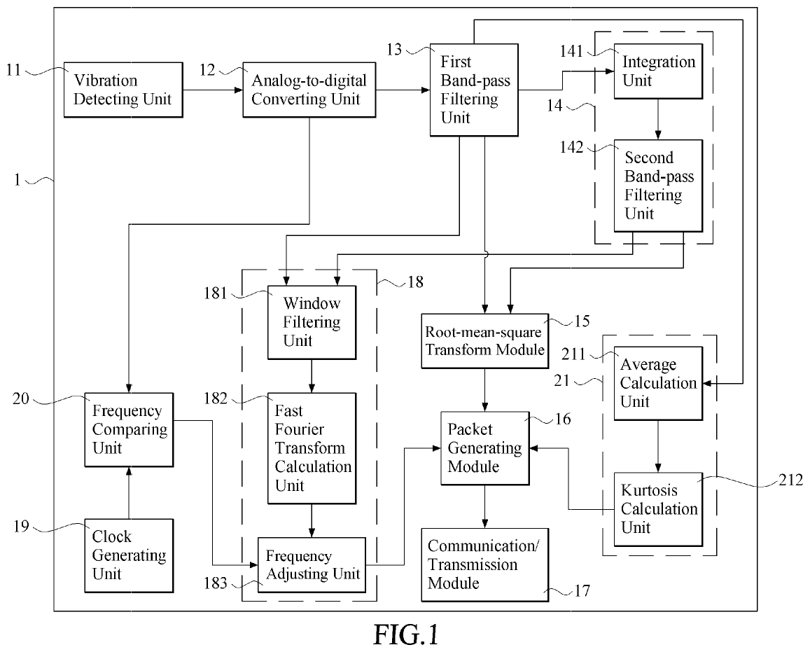

FIG. 1 is a block diagram showing a mobile vibration detecting device in accordance with a preferred embodiment of the present invention. As shown, a mobile vibration detecting device 1 utilized to be carried by a detecting person (not shown) to a motorized machine (not shown) and disposed on the motorized machine for detecting at least one vibration-related data of the motorized machine. The vibration-related data is a function or a value.

The mobile vibration detecting device 1 comprises a vibration detecting unit 11, an analog-to-digital converting unit 12, a first band-pass filtering unit 13, a transform calculation module 14, a root-mean-square (RMS) transform module 15, a packet generating module 16, a communication/transmission module 17, a Fast Fourier Transform module 18, a clock generating unit 19, a frequency comparing unit 20, and a Kurtosis transform module 21.

The vibration detecting unit 11 is utilized to be fixed to the motorized machine for detecting a plurality of acceleration pulses within a detecting time period. Then, the vibration detecting unit 11 generates an acceleration analog signal based on the acceleration pulses.

The analog-to-digital converting unit 12 is electrically connected to the vibration detecting unit 11 for receiving the acceleration analog signal to generate an acceleration digital signal accordingly. This is because the analog signal cannot be dealt with or read by detecting person directly, such that the analog signal should be converted into the digital signal in advance. In the present embodiment, the analog-to-digital converting unit 12 is an analog-to-digital converter (ADC), i.e. A/D or A-to-D.

The first band-pass filtering unit 13 is electrically connected to the analog-to-digital conversion unit 12 for filtering the acceleration digital signal. It is unpreventable to include some noises in the signal, the first band-pass filtering unit 13 is provided for filtering the noises in the acceleration digital signal to leave the signal within a certain frequency band. In the present embodiment, the first band-pass filtering unit 13 is a band pass filter (BPF).

The transform calculation module 14 is electrically connected to the first band-pass filtering unit 13 for receiving the filtered acceleration digital signal to generate a velocity digital signal.

In the present embodiment, the transform calculation module 14 includes an integration unit 141 and a second band-pass filtering unit 142. The integration unit 141 is utilized for receiving the acceleration digital signal and integrating the acceleration digital signal into the velocity digital signal. The second band-pass filtering unit 142 is electrically connected to the integration unit 141 for filtering the velocity digital signal to remove the noises in the velocity digital signal and leave the signal within a certain frequency band. In the present embodiment, the integration unit is an integrator. However, the present invention is not limited thereto. Any component with the function of integration can be deemed as within the scope of the present invention. The second band-pass filtering unit 142 is a band pass filter (BPF) in the present embodiment.

The RMS transform module 15 is electrically connected to the first band-pass filtering unit 13 and the transform calculation module 14 for receiving the acceleration digital signal and the velocity digital signal to generate an acceleration RMS transform data and a velocity RMS transform data respectively. RMS calculation is well understood in the field and thus is not repeated. The RMS transform module 15 can be a processor or a chip with RMS calculation capability.

The acceleration RMS transform data and the velocity RMS transform data can be used to indicate vibration severity, and the standard is well established. Based on ISO10816 vibration severity standard, for an outgoing 50 kW motor, the velocity RMS transform data should be smaller than 1.12 mm/s. The velocity RMS transform data ranged between 1.12 mm/s and 2.8 mm/s is satisfactory, the velocity RMS transform data ranged between 2.8 mm/s and 7.1 mm/s is unsatisfactory, and the velocity RMS transform data greater than 7.1 mm/s is unacceptable, which indicates severe damage.

In general, a vibration with the frequency smaller than 10 Hz is a low frequency vibration, a vibration with the frequency between 10 Hz to 1000 Hz is a normal frequency vibration, and a vibration with the frequency greater than 1000 Hz is a high frequency vibration. The acceleration RMS transform data is applied to the electromechanical device with the vibration frequency ranged between 100 to 10000 Hz, such as the decelerator. The velocity RMS transform data is usually applied to the electromechanical device with the normal frequency vibration, such as the motor, the blower, the electric generator, and etc. As the vibration frequency lays in the overlapping range (100 Hz to 1000 Hz), the velocity RMS transform data is preferred.

The packet generating module 16 is electrically connected to the RMS transform module 15 for receiving the acceleration RMS transform data and the velocity RMS transform data to generate an acceleration RMS transform data packet and a velocity RMS transform data packet respectively. The communication/transmission module 17 is electrically connected to the packet generating module 16 for receiving and transmitting the acceleration RMS transform data packet and the velocity RMS transform data packet.

In order to transmit the detected signal outward, the packet generating module 16 should be used to deal with the acceleration RMS transform data and the velocity RMS transform data as the data of the packet and give a header to the data so as to generate the acceleration RMS transform data packet and the velocity RMS transform data packet. Then, the communication/transmission module 17 is used to transmit the acceleration RMS transform data packet and the velocity RMS transform data packet outward. In the present embodiment, the communication/transmission module 17 is a transmission module compatible with RS-485.

The acceleration RMS transform data packet and the velocity RMS transform data packet are provided to a display module (not shown) adjacent to the motorized machine to display the acceleration RMS transform data and the velocity RMS transform data represented by the acceleration RMS transform data packet and the velocity RMS transform data packet respectively. Thus, the detecting person standing by the motorized machine may check the acceleration RMS transform data and the velocity RMS transform data.

When the acceleration RMS transform data and the velocity RMS transform data checked by the detecting person is within the acceptable range, the motorized machine would be deemed to be fine, and the detecting person may move to other motorized machines. In compared with the prior art, the detecting person using the technology provided in the present embodiment is capable to know if there is any abnormal vibration of the motorized machine at once, and the detecting person is also capable to know if any further detection is needed or if the other motorized machines can be detected.

The Fast Fourier Transform module 18 is electrically connected to the first band-pass filtering unit 13, the transform calculation module 14, and the packet generating module 16 for receiving the acceleration digital signal and the velocity digital signal to generate an acceleration Fourier transform data and a velocity Fourier transform data respectively by using Fast Fourier Transform calculation. Fast Fourier Transform calculation is well understood in the field and thus is not repeated here.

In the present embodiment, the Fast Fourier Transform module 18 includes a window filtering unit 181, a Fast Fourier Transform calculation unit 182, and a frequency adjusting unit 183. The frequency comparing unit 20 is electrically connected to the clock generation unit 19 and the frequency adjusting unit 183 for receiving the acceleration digital signal to generate a frequency difference.

The window filtering unit 181 is utilized for filtering the acceleration digital signal and the velocity digital signal to equate the front-end energy and the rear-end energy of the acceleration digital signal as well as the velocity digital signal. In detail, the window filtering unit 181 is a window filter, which accesses the signal portion of the digital signal at a certain time and adjusts the signal accordingly to equate the energy value of the signal at the signal starting time and the energy value of the signal at the signal ending time so as to make the signal similar to a periodic signal.

The Fast Fourier Transform calculation unit 182 is electrically connected to the window filtering unit 181 for transforming the acceleration digital signal and the velocity digital signal by using Fast Fourier Transform to generate an original acceleration Fourier Transform data and an original velocity Fourier Transform data. Because the acceleration digital signal and the velocity digital signal has been manipulated by the window filtering unit 181 to make the signals similar to periodic signals, the Fast Fourier Transform calculation can be used. The Fast Fourier Transform calculation unit 182 can be a processor or a chip with Fast Fourier Transform calculation capability.

The frequency adjusting unit 183 is electrically connected to the Fast Fourier Transform calculation unit 182 and the frequency comparing unit 20 for receiving the frequency difference, the original acceleration Fourier Transform data, and the original velocity Fourier Transform data, and using the frequency difference to execute a frequency difference adjusting calculation to the original acceleration Fourier Transform data and the original velocity Fourier Transform data to generate the acceleration Fourier Transform data and the velocity Fourier Transform data. The acceleration Fourier Transform data and the velocity Fourier Transform data are functions.

It should be mentioned that in the present embodiment, the vibration detecting unit 11 is a microelectromechanical sensor, which might have clock error in general. Thus, the clock generating unit 19 is used in the present embodiment to generate a reference clock, and the frequency comparing unit 20 is used to compare the clock and the reference clock so as to have the clock adjusting unit 183 adjusting the frequency used in Fast Fourier Transform calculation. For example, assume the clock is 1% slower than the reference clock, the frequency of the original velocity Fourier transform data should be multiplied by the clock and further divided by the reference clock to access the real frequency.

Take the actual numbers for example, if the reference clock is 100 kHz, the clock of the vibration detecting unit 11 is 99 kHZ, and the frequency of a signal is 990 Hz, the frequency of the signal would be regarded as 1000 Hz after Fast Fourier Transform calculation. Thus, the frequency comparing unit 20 may adjust the frequency of the signal, i.e. 1000 Hz, by having the frequency multiplied by 99 (clock) and further divided by 100 (reference clock).

The Fast Fourier Transform module 18 uses Fourier algorithm to transform the amplitudes into vibration energy distribution of certain frequency points (i.e. frequency domain). Vibration energy of the motorized machine can be found at some specific frequency points (e.g. baseband, second harmonic generation, third harmonic generation, and etc.), and thus vibration energy distribution can be used to determine the condition of the motorized machine.

If the velocity Fourier transform data shows that most of the vibration energy happens at baseband, i.e. fundamental frequency, the motorized machine would be under a unbalance condition. If the velocity Fourier transform data shows that most of the vibration energy happens at second harmonic generation, the motorized machine would be under an asymmetric condition. If the velocity Fourier transform data shows that most of the vibration energy happens at base-band and second harmonic generation, the motorized machine may have some minor deformation or unstable problem. If the velocity Fourier transform data shows that most of the vibration energy happens at base-band, second harmonic generation, third harmonic generation, fourth harmonic generation, fifth harmonic generation, and sixth harmonic generation, some components of the motorized machine may be loosened. It should be mentioned that the aforementioned conditions are under the premise that the velocity RMS transform data excesses the satisfactory range, i.e. for ISO10816 standard, the velocity RMS transform data is greater than 2.8 mm/s.

The packet generating module 16 receives the acceleration Fourier transform data and the velocity Fourier transform data to generate an acceleration Fourier transform data packet and a velocity Fourier transform data packet accordingly. The communication/transmission module 17 receives and transmits the acceleration Fourier transform data packet and the velocity Fourier transform data packet. The display module disposed by the motorized machine receives the acceleration Fourier transform data packet and the velocity Fourier transform data packet, and displays the acceleration Fourier transform data and the velocity Fourier transform data represented by the acceleration Fourier transform data packet and the velocity Fourier transform data packet respectively for the detecting person to do the aforementioned detection.

The Kurtosis transform module 21 is electrically connected to the first band-pass filtering unit 13 and the packet generating module 16 for receiving the acceleration digital signal to generate a Kurtosis transform data accordingly. In the present embodiment, the Kurtosis transform module 21 can be a calculator, a processor, or a chip with Kurtosis calculation capability. The Kurtosis transform data is a value. The packet generating module 16 receives the Kurtosis transform data to generate a Kurtosis transform data packet. The communication/transmission module 17 receives and transmits the Kurtosis transform data packet.

In the present embodiment the Kurtosis transform module 21 includes an average calculation unit 211 and the Kurtosis calculation unit 212. The average calculation unit 211 is utilized for calculating an average value of acceleration. The Kurtosis calculation unit 212 is electrically connected to the average calculation unit 211 for receiving the average value and generating the above-mentioned Kurtosis transform data accordingly. The function of Kurtosis calculation has a nominator, which is an expectation value of the fourth power of the difference between the vibration acceleration and the average value, and a denominator, which is the square of an expectation value of the square of the difference between the vibration acceleration and the average value. By using the aforementioned calculation, the Kurtosis transform data can be generated.

In general, the value of Kurtosis transform data would be smaller than 3. The Kurtosis transform data greater than 5 represents that the motorized machine is damaged, especially the damage of rolling balls in the bearing. It should be noted that the aforementioned condition is under the premise that the velocity RMS transform data excesses the satisfactory range. If most of the energy of the velocity Fourier transform data also happens at the frequency greater than 25th harmonic generation, the condition of bearing failure can be determined.

The packet generating module 16 receives the Kurtosis transform data to generate a Kurtosis transform data packet accordingly. The communication/transmission module 17 receives and transmits the Kurtosis transform data packet. The display module disposed by the motorized machine receives the Kurtosis transform data packet to display the Kurtosis transform data represented by the Kurtosis transform data packet for the detecting person to read.

The display module can be a monitor, which can be a separate screen disposed by the motorized machine or a screen of the mobile electronic device.

The mobile vibration detecting device 1 provided in the present invention is capable to transmit the acceleration RMS transform data packet, the velocity RMS transform data packet, the acceleration Fourier transform data packet, the velocity Fourier transform data packet, and the Kurtosis transform data packet and use the display module to show the acceleration RMS transform data, the velocity RMS transform data, the acceleration Fourier transform data, the velocity Fourier transform data, and the Kurtosis transform data for the detecting person standing by the motorized machine to read. Thus, the problems of the prior art caused by analog signal transmission to the back end can be resolved.

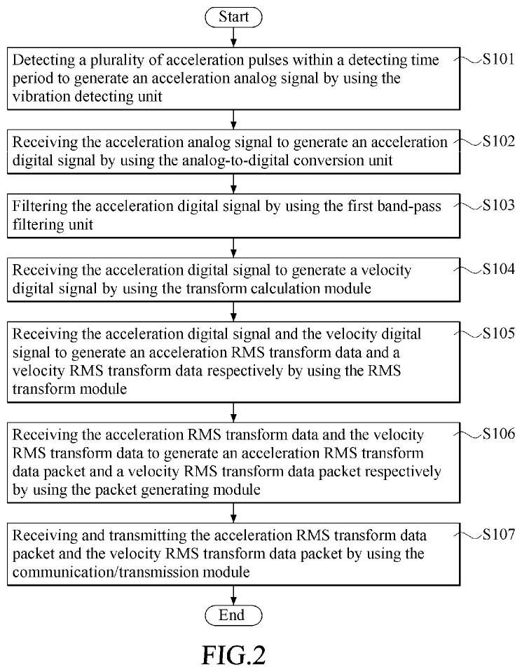

Please refer to FIG. 2, which is a flow chart showing a mobile vibration detecting method in accordance with a first preferred embodiment of the present invention. As shown, the mobile vibration detecting method is executed by using the mobile vibration detecting device 1 shown in FIG. 1, and the mobile vibration detecting method comprises the following steps S101 to S107.

Step S101: detecting a plurality of acceleration pulses within a detecting time period to generate an acceleration analog signal by using the vibration detecting unit 11.

Step S102: receiving the acceleration analog signal to generate an acceleration digital signal by using the analog-to-digital conversion unit 12.

Step S103: filtering the acceleration digital signal by using the first band-pass filtering unit 13.

Step S104: receiving the acceleration digital signal to generate a velocity digital signal by using the transform calculation module 14.

Step S105: receiving the acceleration digital signal and the velocity digital signal to generate an acceleration RMS transform data and a velocity RMS transform data respectively by using the RMS transform module 15.

Step S106: receiving the acceleration RMS transform data and the velocity RMS transform data to generate an acceleration RMS transform data packet and a velocity RMS transform data packet respectively by using the packet generating module 16.

Step S107: receiving and transmitting the acceleration RMS transform data packet and the velocity RMS transform data packet by using the communication/transmission module 17.

Wherein, a display module disposed by the motorized machine shows the acceleration RMS transform data and the velocity RMS transform data represented by the acceleration RMS transform data packet and the velocity RMS transform data packet respectively for the detecting person standing by the motorized machine to read.

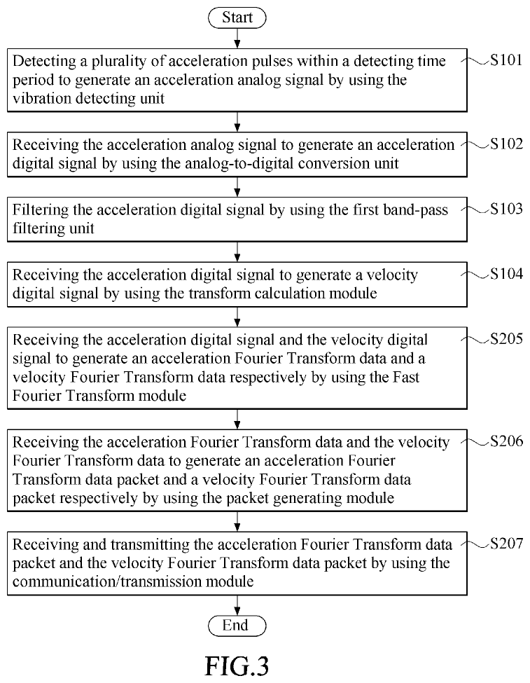

Please refer to FIG. 3, which is a flow chart showing a mobile vibration detecting method in accordance with a second preferred embodiment of the present invention. As shown, the mobile vibration detecting method is executed by using the mobile vibration detecting device 1 shown in FIG. 1, and the mobile vibration detecting method comprises the following steps, of which steps S101 to S104 are identical to FIG. 2 and thus are not repeated.

Step S205: receiving the acceleration digital signal and the velocity digital signal to generate an acceleration Fourier Transform data and a velocity Fourier Transform data respectively by using the Fast Fourier Transform module 18.

Step S206: receiving the acceleration Fourier Transform data and the velocity Fourier Transform data to generate an acceleration Fourier Transform data packet and a velocity Fourier Transform data packet respectively by using the packet generating module 16.

Step S207: receiving and transmitting the acceleration Fourier Transform data packet and the velocity Fourier Transform data packet by using the communication/transmission module 17.

Wherein, a display module disposed by the motorized machine shows the acceleration Fourier transform data and the velocity Fourier transform data represented by the acceleration Fourier transform data packet and the velocity Fourier transform data packet respectively for the detecting person standing by the motorized machine to read.

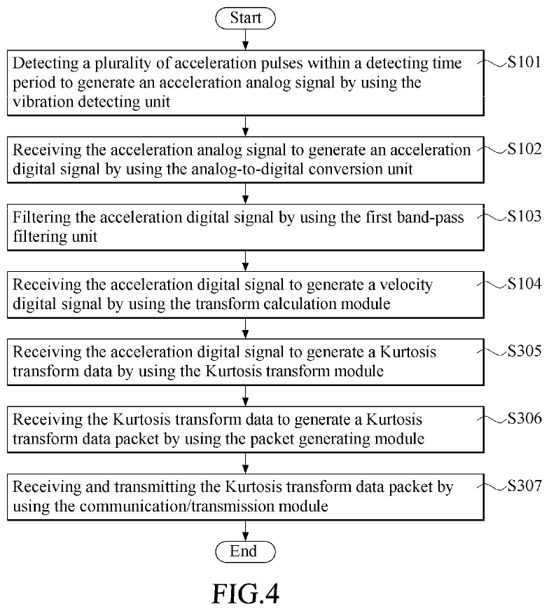

Finally, please refer to FIG. 4, which is a flow chart showing a mobile vibration detecting method in accordance with a third preferred embodiment of the present invention. As shown, the mobile vibration detecting method is executed by using the mobile vibration detecting device 1 shown in FIG. 1, and the mobile vibration detecting method comprises the following steps, of which steps S101 to S104 are identical to FIG. 2 and thus are not repeated.

Step S305: receiving the acceleration digital signal to generate a Kurtosis transform data by using the Kurtosis transform module 21.

Step S306: receiving the Kurtosis transform data to generate a Kurtosis transform data packet by using the packet generating module 16.

Step S307: receiving and transmitting the Kurtosis transform data packet by using the communication/transmission module 17.

Wherein, a display module disposed by the motorized machine shows the Kurtosis transform data represented by the Kurtosis transform data packet for the detecting person standing by the motorized machine to read.

Please refer to FIG. 2 to FIG. 4, the steps S105 to S107 in FIG. 2 are defined as a first step group, the steps S205 to S207 in FIG. 3 are defined as a second step group, and the steps S305 to S307 in FIG. 4 are defined as a third step group.

The first step group, the second step group and the third step group can be changed or integrated according to the need in practice. Preferably, the second step group follows the first step group, and the third step groups follows the first step group and the second step group because the acceleration RMS transform data and the velocity RMS transform data generated by the first step group can be used for determining whether the motorized machine is under the abnormal condition.

The order of the steps in each of the step groups is fixed. That is, in the first step group, the step S105 is executed first, the step S106 follows, and finally the step S107 is executed. The same limitation also applies to the second step group and the third step group, which is not repeated here.

In conclusion, the mobile vibration detecting device and the detecting method thereof uses the analog-to-digital converting unit, the first band-pass filtering unit, the transform calculation module, the RMS transform module, the packet generating module, and the communication/transmission module to transmit the acceleration RMS transform data packet and the velocity RMS transform data packet directly for the detecting person the read the acceleration RMS transform data and the velocity RMS transform data represented by the acceleration RMS transform data packet and the velocity RMS transform data packet.

In compared with the conventional technology, the mobile vibration detecting device and the detecting method thereof provided in the present invention is capable for providing the readable information to the detecting person standing by the motorized machine without the need of back end calculation, such that the problems of the prior art caused by signal transmission to the back end can be resolved.

While the present invention has been particularly shown and described with reference to a preferred embodiment, it will be understood by those skilled in the art that various changes in form and detail may be without departing from the spirit and scope of the present invention.

What is claimed is:

1. A mobile vibration detecting device, carried by a detecting person and disposed on a motorized machine for detecting at least one vibration-related data of the motorized machine, comprising:
a vibration detecting unit, fixed to the motorized machine for detecting a plurality of acceleration pulses within a detecting time period to generate an acceleration analog signal;
an analog-to-digital converting unit, electrically connected to the vibration detecting unit for receiving the acceleration analog signal to generate an acceleration digital signal;
a first band-pass filtering unit, electrically connected to the analog-to-digital conversion unit for filtering the acceleration digital signal;
a transform calculation module, electrically connected to the first band-pass filtering unit for receiving the acceleration digital signal to generate a velocity digital signal;
a root-mean-square (RMS) transform module, electrically connected to the first band-pass filtering unit and the transform calculation module for receiving the acceleration digital signal and the velocity digital signal to generate an acceleration RMS transform data and a velocity RMS transform data respectively;
a packet generating module, electrically connected to the RMS transform module for receiving the acceleration RMS transform data and the velocity RMS transform data to generate an acceleration RMS transform data packet and a velocity RMS transform data packet respectively; and
a communication/transmission module, electrically connected to the packet generating module for receiving and transmitting the acceleration RMS transform data packet and the velocity RMS transform data packet;
wherein the acceleration RMS transform data packet and the velocity RMS transform data packet are provided to a display module adjacent to the motorized machine to display the acceleration RMS transform data and the velocity RMS transform data represented by the acceleration RMS transform data packet and the velocity RMS transform data packet respectively for the detecting person to read.

2. The mobile vibration detecting device of claim 1, wherein the transform calculation module includes an integration unit, which is utilized for integrating the acceleration digital signal into the velocity digital signal.

3. The mobile vibration detecting device of claim 1, wherein the transform calculation module includes a second band-pass filtering unit, which is utilized for generating the velocity digital signal.

4. The mobile vibration detecting device of claim 1, further comprising a Fast Fourier Transform module, which is electrically connected to the first band-pass filtering unit, the transform calculation module, and the packet generating module for receiving the acceleration digital signal and the velocity digital signal to generate an acceleration Fourier Transform data and a velocity Fourier Transform data respectively, wherein the packet generating module is utilized for receiving the acceleration Fourier Transform data and the velocity Fourier Transform data to generate an acceleration Fourier Transform data packet and a velocity Fourier Transform data packet respectively, and the acceleration Fourier Transform data packet and the velocity Fourier Transform data packet are transmitted by the communication/transmission module.

5. The mobile vibration detecting device of claim 4, further comprising:
a clock generation unit; and
a frequency comparing unit, electrically connected to the analog-to-digital conversion unit and the clock generation unit for receiving the acceleration digital signal to generate a frequency difference.

6. The mobile vibration detecting device of claim 5, wherein the Fast Fourier Transform module comprises:
a window filtering unit, utilized for filtering the acceleration digital signal and the velocity digital signal;
a Fast Fourier Transform calculation unit, electrically connected to the window filtering unit for transforming the filtered acceleration digital signal and the filtered velocity digital signal by using Fast Fourier Transform to generate an original acceleration Fourier Transform data and an original velocity Fourier Transform data; and
a frequency adjusting unit, electrically connected to the Fast Fourier Transform calculation unit and the frequency comparing unit for receiving the frequency difference, the original acceleration Fourier Transform data, and the original velocity Fourier Transform data, and using the frequency difference to execute a frequency difference adjusting calculation to the original acceleration Fourier Transform data and the original velocity Fourier Transform data to generate the acceleration Fourier Transform data and the velocity Fourier Transform data.

7. The mobile vibration detecting device of claim 1, further comprising a Kurtosis transform module, which is electrically connected to the first band-pass filtering unit and the packet generating module for receiving the acceleration digital signal to generate a Kurtosis transform data, wherein the packet generating module is utilized for receiving the Kurtosis transform data to generate a Kurtosis transform data packet, and the Kurtosis transform data packet is transmitted by the communication/transmission module.

8. The mobile vibration detecting device of claim 7, wherein the Kurtosis transform module comprises:
an average calculation unit, utilized for calculating an average value; and
a Kurtosis calculation unit, electrically connected to the average calculation unit for receiving the average value to generate the Kurtosis transform data.

9. A mobile vibration detecting method using the mobile vibration detecting device of claim 1 to detect at least one vibration-related data of the motorized machine comprising:
(a) detecting a plurality of acceleration pulses within a detecting time period to generate an acceleration analog signal by using the vibration detecting unit;
(b) receiving the acceleration analog signal to generate an acceleration digital signal by using the analog-to-digital conversion unit;
(c) filtering the acceleration digital signal by using the first band-pass filtering unit;
(d) receiving the acceleration digital signal to generate a velocity digital signal by using the transform calculation module;
(e) receiving the acceleration digital signal and the velocity digital signal to generate an acceleration RMS transform data and a velocity RMS transform data respectively by using the RMS transform module;
(f) receiving the acceleration RMS transform data and the velocity RMS transform data to generate an acceleration RMS transform data packet and a velocity RMS transform data packet respectively by using the packet generating module; and
(g) receiving and transmitting the acceleration RMS transform data packet and the velocity RMS transform data packet by using the communication/transmission module.

10. The mobile vibration detecting method of claim 9, wherein the mobile vibration detecting device further comprises a Fast Fourier Transform module, which is electrically connected to the first band-pass filtering unit, the transform calculation module, and the packet generating module, further comprising:
(h) receiving the acceleration digital signal and the velocity digital signal to generate an acceleration Fourier Transform data and a velocity Fourier Transform data respectively by using the Fast Fourier Transform module;
(i) receiving the acceleration Fourier Transform data and the velocity Fourier Transform data to generate an acceleration Fourier Transform data packet and a velocity Fourier Transform data packet respectively by using the packet generating module; and
(j) receiving and transmitting the acceleration Fourier Transform data packet and the velocity Fourier Transform data packet by using the communication/transmission module.

11. The mobile vibration detecting method of claim 9, wherein the mobile vibration detecting device further comprises a Kurtosis transform module, which is electrically connected to the first band-pass filtering unit and the packet generating module, further comprising:
(k) receiving the acceleration digital signal to generate a Kurtosis transform data by using the Kurtosis transform module;
(l) receiving the Kurtosis transform data to generate a Kurtosis transform data packet by using the packet generating module; and
(m) receiving and transmitting the Kurtosis transform data packet by using the communication/transmission module.
